(19) United States
(12) Patent Application Publication
(10) Pub. No.: US 2019/0039221 A1
(43) Pub. Date: Feb. 7, 2019

(54) MAGAZINE ASSEMBLY AND A STAPLER INCLUDING THE SAME

(71) Applicant: APEX MFG. CO., LTD., Taichung City (TW)

(72) Inventors: Jing- Li WANG, Taichung City (TW); Py-Yi CHANG, Taichung City (TW)

(21) Appl. No.: 15/669,341

(22) Filed: Aug. 4, 2017

(51) Int. Cl. B25C 5/02; B25C 5/16; B25C 5/11

(52) U.S. Cl. CPC B25C 5/0285; B25C 5/1696; B25C 5/11; B25C 5/1617

(57) ABSTRACT

A magazine assembly and a stapler including the same are provided. The magazine assembly includes a base and a rail assembly. The base has a first end portion and a second end portion. A direction from the second end portion toward the first end portion is defined as a first direction. The rail assembly is disposed on the base and adapted for a staple unit to slidably abut thereagainst along the first direction. The rail assembly includes a first rail and a second rail which are separate. A first side wall of the first rail has at least one guiding portion extending in the first direction. Each guiding portion is adapted for a head of a T-shaped staple to slidably engage therewith along the first direction. The second rail is adapted for a U-shaped staple unit to abut thereagainst.

### BACKGROUND OF THE INVENTION

### Field of the Invention

The present invention relates to a magazine assembly and a stapler including the same.

### Description of the Prior Art

A stapler is an essential tool for woodworkers, the stapler connects different wood materials together. Users can discharge the staples only by pressing the pressing member. However, inventors of the conventional stapler only focus on the effort-saving mechanism of the stapler, but ignore configuration structures between a magazine assembly and staples effect a stability of discharging, and further effect the quality of assembled products.

The present invention is, therefore, arisen to obviate or at least mitigate the above mentioned disadvantages.

### SUMMARY OF THE INVENTION

The main object of the present invention is to provide a magazine assembly and a staple including the same which is applied for different staples (such as T-shaped staples, U-shaped staples or reverse U-shaped staples), and is adapted for the T-shaped staples with different lengths to abut against a base exactly to improve the quality of discharging the staples.

To achieve the above and other objects, the magazine assembly includes a base and a rail assembly. The base has a first end portion and a second end portion. A direction from the second end portion toward the first end portion is defined as a first direction. The rail assembly is disposed on the base and adapted for a staple unit to movably abut thereagainst along the first direction. The rail assembly includes a first rail and a second rail which are separate. A first side wall of the first rail has at least one guiding portion extending in the first direction. Each guiding portion is adapted for a head of a T-shaped staple to slidably engage therewith along the first direction. The second rail is adapted for a U-shaped staple to abut thereagainst.

To achieve the above and other objects, further includes the stapler includes a main body, a shell and an impact plate. The main body includes a pressing member. A shell has a receive portion, the magazine assembly and the shell define a discharge opening therebetween. The discharge opening is for corresponding by the staple unit, the pressing member and the impact plate drive mutually. When the pressing member is moved relative to the shell, the pressing member drives the impact plate to move toward an opening of the discharge opening to discharge part of the staple unit.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a breakdown view of the FIG. 1;

FIG. 3 is a stereogram of a magazine assembly of the preferred embodiment of the present invention;

FIG. 4 is a breakdown view of the FIG. 3;

FIG. 5 is a partially-enlarged view of the magazine assembly of the preferred embodiment of the present invention;

FIG. 6 to FIG. 8 are a partial cross-sectional view of the magazine assembly of the preferred embodiment of the present invention; and

FIG. 9. is a partial cross-sectional view of another preferred embodiment of a first rail.

### DETAILED DESCRIPTION OF THE PREFERRED EMBODIMENTS

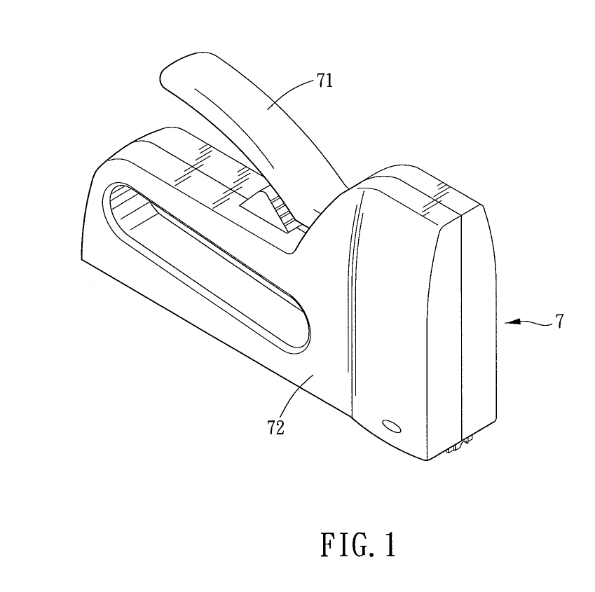

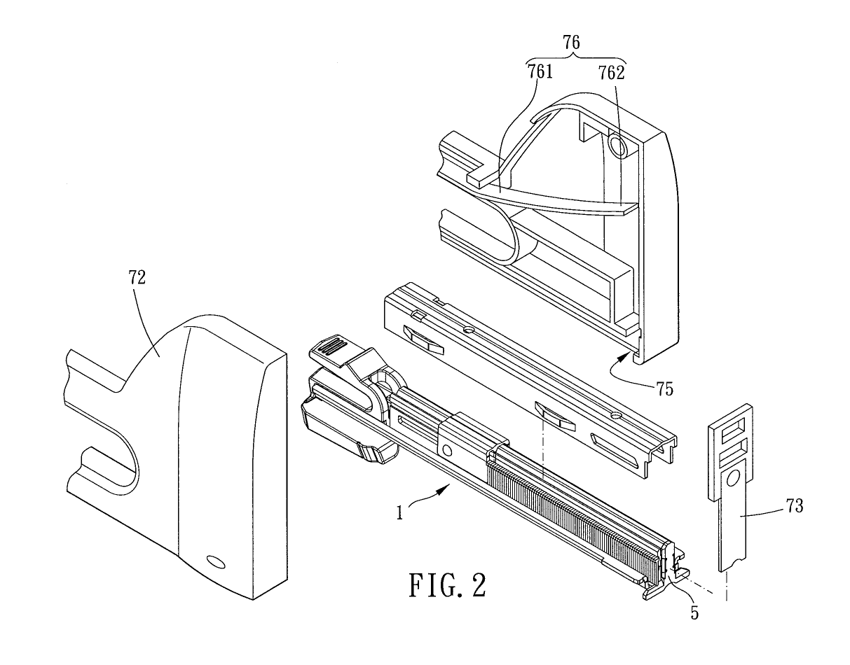

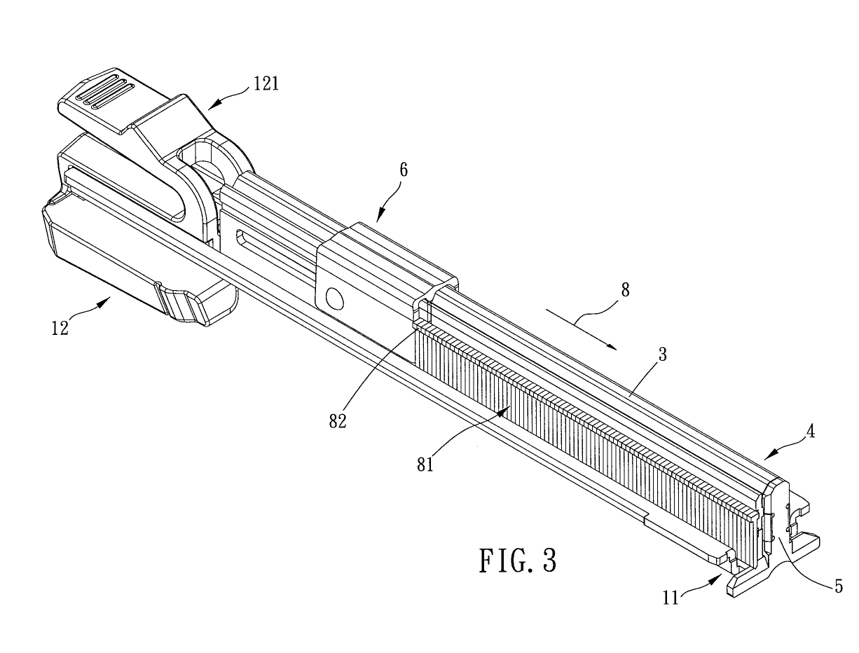

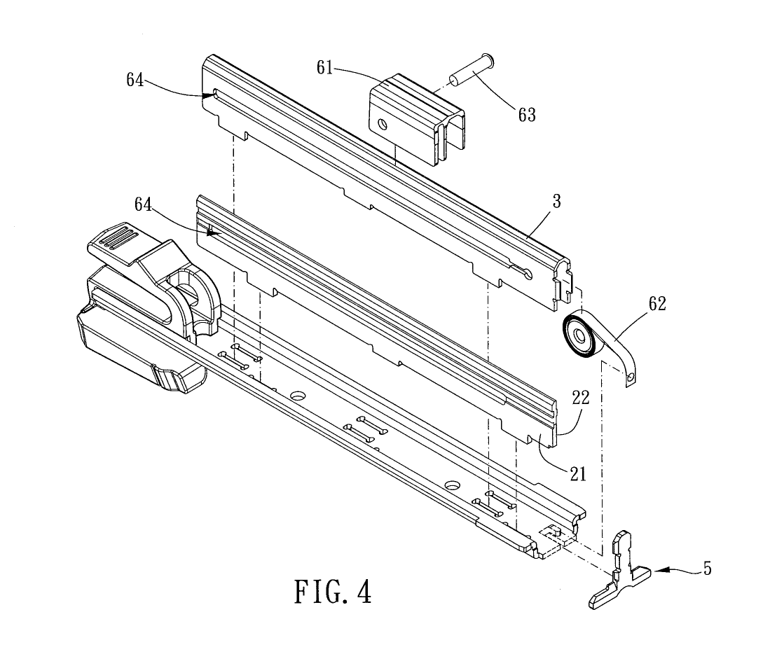

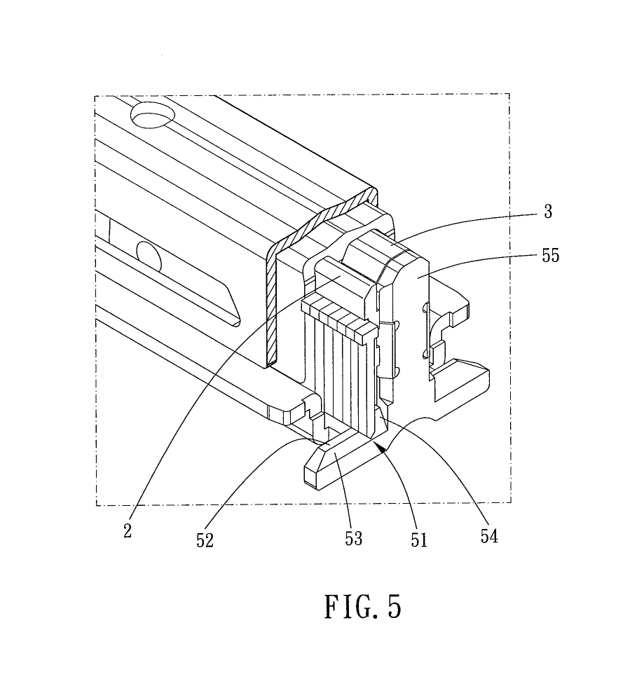

Please refer to FIG. 1 to FIG. 8, the magazine Assembly and a stapler including the same.

The stapler not only includes the magazine assembly, but also further includes a main body 7. The main body 7 includes a pressing member 71, a shell 72 and an impact plate 73. The shell 72 has a receive portion 74 receiving the magazine assembly. The magazine assembly and the shell 72 define a discharge opening 75 therebetween, the discharge opening 75 is for corresponding by the staple unit. The pressing member 71 and the impact plate 73 drive mutually, when the pressing member 71 is moved relative to the shell 72, the pressing member 71 drives the impact plate 73 to move toward the discharge opening 75 to discharge part of the staple unit.

In this embodiment, the main body 7 further includes an elastic plate 76 disposed in the shell 72, the elastic plate 76 has a fixation portion 761 abutting against the shell 72 and a swing portion 762, the swing portion 762 is connected to the impact plate 73 and bends relative to the fixation portion 761, and when the pressing member 71 is moved relative to the shell 72 to a predetermined position, the elastic plate 76 drives the impact plat 73 move toward the discharge opening 75. In other words, the rebound force of the elastic plate 76 forces the impact plate 73 to impact part of the staple unit. Wherein there is a variety of staple units, such as but not limited to T-shaped staples, U-shaped staples, reverse U-shaped staples, and roof-shaped staples.

The description of the magazine assembly is given below. The magazine assembly is configured to be assembled to a stapler, includes a base 1 and a rail assembly 4. The base 1 has a first end portion 11 and a second end portion 12, a direction from the second end portion 12 toward the first end portion 11 is defined as a first direction 8. The rail assembly 4 is disposed on the base 1 and adapted for a staple unit to movably abut thereagainst along the first direction 8. The rail assembly 4 includes a first rail 2 and a second rail 3 which are separate. In this embodiment, the first and second rails 2, 3 are detachably inserted into and positioned on the base 1; and a longest distance between the first rail 2 and the base 1 is substantially equal to a longest distance between the second rail 3 and the base 1; in other words, both have a similar horizontal height. Understandably, in other embodiments, the first rail and the second rail are made integrally with the base which is just a simple change of the embodiment of the present invention.

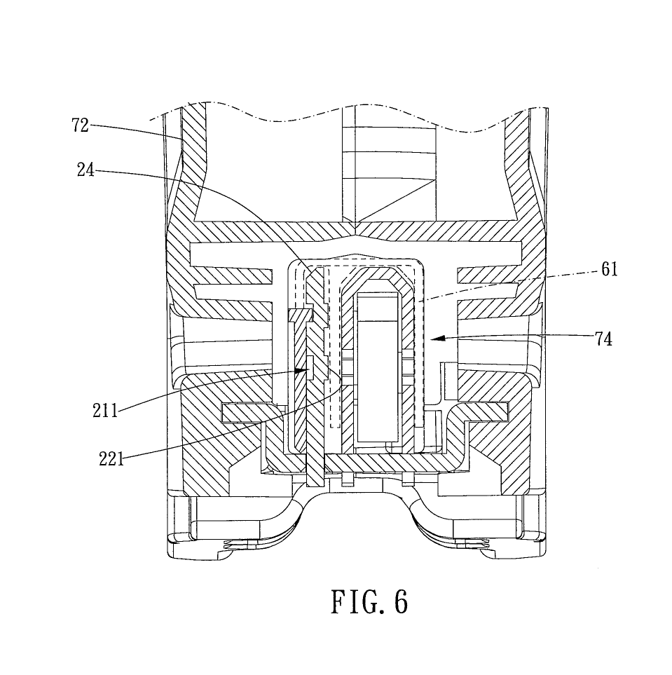

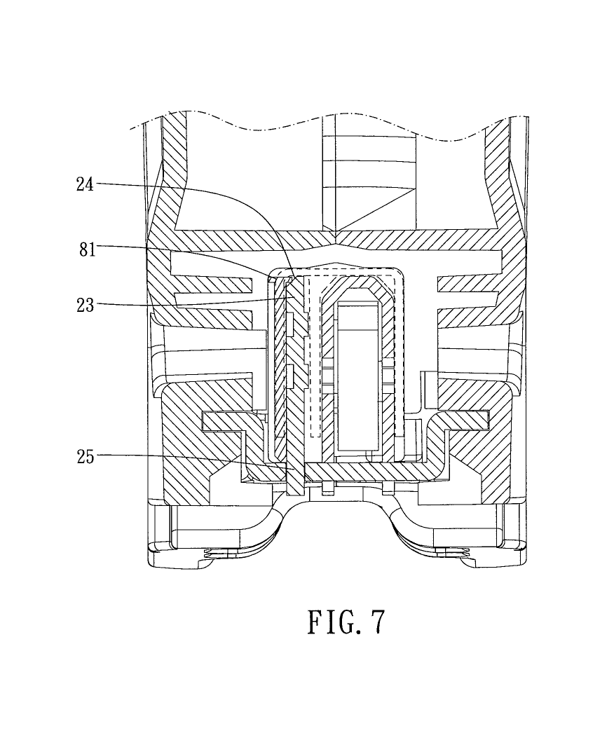

A first side wall 21 of the first rail 2 has at least one guiding portion 211 extending in the first direction 8, the at least one guiding portion 211 is adapted for a head 82 of a T-shaped staple unit 81 to slidably engage therewith along the first direction 8. Thereby, a number of the at least one guiding portion 211 can be plural. When the first side wall 21 has the plural guiding portions 211 arranged perpendicularly to the first direction 8, users can insert the T-shaped staple unit 81 into one of suitable the guiding portions 211 according to a length of the T-shaped staple unit 81, so as to keep the T-shaped staple unit 81 touching the base 1 exactly (as shown in FIGS. 6-7), and to increase a stability of discharging and an accuracy of a location of the staple after discharging.

Besides, when the T-shaped staple unit 81 is impacted by the impact plate 73, the head 82 of the T-shaped staple unit 81 can be prevent from moving in a direction away from the discharge opening 75 by a wide margin (even not moving in a direction away from the discharge opening 75) by a reaction force because of the T-shaped staple unit 81 is disposed inside the guiding portion 211 so as to let the T-shaped staple unit 81 has a better discharge state, and to make sure that part of an unused T-shaped staple unit 81 remains a complete structure. Understandably, the second rail 3 is adapted for a U-shaped staple unit 83 of the staple unit to abut thereagainst independently.

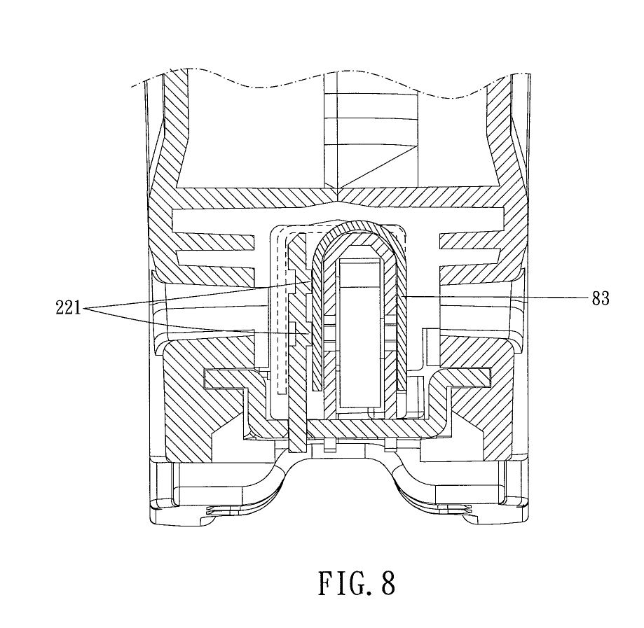

Furthermore, the first rail 2 further includes a second side wall 22, the second side wall 22 and the first side wall 21 are substantially parallel. In this embodiment, the first side wall 21 faces in a direction away from the second rail 3, the second side wall 22 faces the second rail 3. The second side wall 22 has at least one rib portion 221 extending along the first direction 8, the at least one rib portion 221 corresponds to the at least one guiding portion 211 so as to enhance a strength of the first rail 2. Preferably, the at least one rib portion 221 protrudes toward the second rail 3, the at least one rib portion 221 is for being abutted against by the U-shaped staple unit 83 laterally so as to increase the stability of using the magazine assembly (as shown in FIG. 8).

Furthermore, the first rail 2 further includes a top portion 23 and a bottom portion 25 which is connected with the first side wall 21 and the second side wall 22, the bottom portion 25 is connected with the base 1, the top portion 23 has an inclined face 24, the inclined face 24 extends slantly from the second side wall 22 to the first side wall 21 and the base 1. When the length of the T-shaped staple unit 81 is too long to dispose into the guiding portion 211, the inclined face 24 is for being abutted against by the head 82 of the T-shaped staple unit 81. Wherein, a continuous design of the inclined face 24 can be applied for the T-shaped staple units 81 with different lengths to abut against the base 1 exactly. In this embodiment, a number of the at least one guiding portion 211 is two and a number of the at least one rib portion 221 is two, a distance between two guiding portions 211 is substantially equal to a shortest distance between the inclined face 24 and one of the guiding portion 211 which is closest to the inclined face 24.

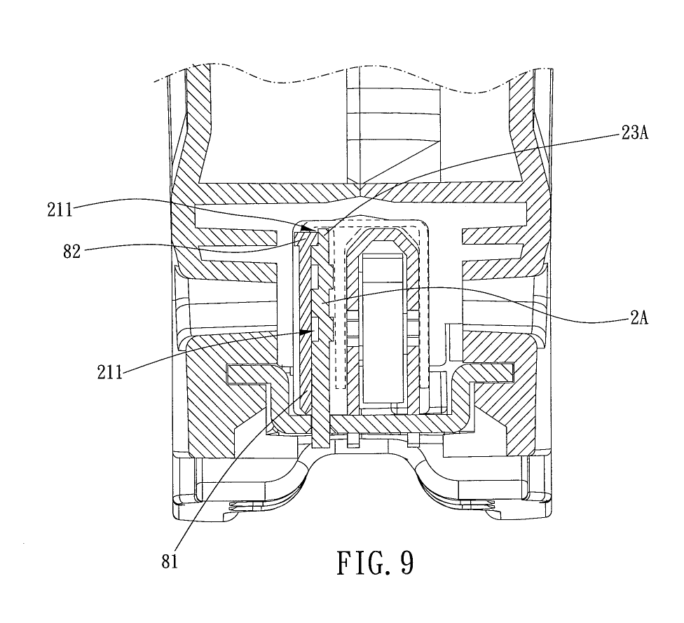

Of course, the present invention is not limited to the embodiment above. In other embodiments, the top portion 23 can be not disposed on the inclined face 24. For example but not to be limited, as shown in FIG. 9, it is another embodiment of a top portion 23A of a first rail 2A, the guiding portion 211 is disposed at the top portion 23A so that the head 82 of T-shaped with longer length can be abutted thereagainst.

Please refer to FIG. 1-8 again, it is noted that the magazine assembly further includes a split member 5. The split member 5 is disposed on the first end portion 11, the first end portion 11 is approximating to the impact plate 73 of the stapler, the split member 5 has a cutting portion 51 extending laterally to the first direction 8, and the T-shaped staple unit 81 extends partially beyond the cutting portion 51 in the first direction 8 for being impacted by the impact plate 73. Specifically, the T-shaped staple unit 81 includes a plurality of T-shaped staple members continuously arranged in line, the cutting portion 51 has a support face 52 and a guide face 53, the guide face 53 is connected with the support face 52 slantly; wherein the support face 52 is for supporting the T-shaped staple unit 81 and part of the T-shaped staple members is located beyond the support face 52, suspends and corresponds to the guide face 53. After part of the T-shaped unit 81 which is located beyond the support face 52 is impacted by the impact plate 73, part of the T-shaped staple members will be split from the T-shaped staple unit 81 and slide down along the guide face 53.

Preferably, the cutting portion 51 further includes an abutted section 54, the abutted section 54 protrudes from the support face 52 and is for being abutted against laterally by the T-shaped staple unit 81 so as to increase the stability of discharging. In this embodiment, the split member 5 further includes a connection portion 55, the connection portion 55 is perpendicular to the cutting portion 51 and the first direction 8; the connection portion 55 is clamped by a clamping portion of the second rail 3 to be positioned at the first end portion 11; as viewed in the first direction 8, the split member 5 is substantially T-shaped.

Moreover, the magazine assembly further includes a pushing mechanism 6, the pushing mechanism 6 has a pushing member 61, at least one resilient member 62, a pivot member 63 and a via groove 64 disposed through the first and second rails 2, 3, the via groove 64 extends along the first direction 8, the pivot member 63 is slidably disposed in the via groove 64 and connected with the pushing member 61, one end of the resilient member 62 is connected with the first end portion 11, and another end of the resilient member 62 is connected with the pushing member 61 so that the resilient member 62 bias the pushing member 61 moved toward the first end portion 11. Besides, the magazine assembly further includes a positioning mechanism 121 disposed at the second end portion 12, the positioning mechanism 121 is for being abutted against by and positioned with the stapler.

Given the above, the magazine assembly and the stapler including the same of the present invention, it can be applied for the T-shaped staples with different lengths to keep abutting against the base 1 by the different height of the guiding portions 211 so as to discharge stably. In addition, each of the guiding portions 211 can resist the reaction force from discharging so as to keep the original structure and better use of state of the present invention.

While we have shown and described various embodiments in accordance with the present invention, it should be clear to those skilled in the art that further embodiments may be made without departing from the scope of the present invention.

What is claimed is:

1. A magazine assembly, configured to be assembled to a stapler, including:
a base, having a first end portion and a second end portion, a direction from the second end portion toward the first end portion being defined as a first direction;
a rail assembly, disposed on the base and adapted for a staple unit to movably abut thereagainst along the first direction, including a first rail and a second rail which are separate, a first side wall of the first rail having at least one guiding portion extending in the first direction, the at least one guiding portion being adapted for a head of a T-shaped staple unit to slidably engage therewith along the first direction, the second rail being adapted for a U-shaped staple of the staple unit to abut thereagainst.

2. The magazine assembly of claim 1, further including a split member, the split member disposed on the first end portion, the first end portion approximating to an impact plate of the stapler, the split member having a cutting portion extending laterally to the first direction, the T-shaped staple unit extending partially beyond the cutting portion in the first direction for being impacted by the impact plate.

3. The magazine assembly of claim 2, wherein the T-shaped staple unit includes a plurality of T-shaped staple members continuously arranged in line, the cutting portion has a support face and a guide face, the guide face is connected with the support face slantly; wherein the support face is for supporting the T-shaped staple unit, and part of the T-shaped staple members is located beyond the support face, suspends and corresponds to the guide face.

4. The magazine assembly of claim 3, wherein the cutting portion further includes an abutted section, the abutted section protrudes from the support face and is for being abutted against laterally by the T-shaped staple unit.

5. The magazine assembly of claim 1, wherein the first rail further includes a second side wall, the second side wall and the first side wall are substantially parallel, the second side wall has at least one rib portion extending along the first direction, the at least one rib portion corresponds to the at least one guiding portion, and the at least one rib portion protrudes toward the second rail.

6. The magazine assembly of claim 5, wherein the first rail further includes a top portion and a bottom portion which are connected with the first side wall and the second side wall, the bottom portion is connected with the base, the top portion has an inclined face, the inclined face extends slantly from the second side wall toward the first side wall and the base, and the inclined face is for being abutted against by the head of the T-shaped staple unit.

7. The magazine assembly of claim 5, wherein the at least one rib portion is for being abutted against by a U-shaped staple unit laterally.

8. The magazine assembly of claim 7, further including a split member, the split member disposed on the first end portion, the first end portion approximating to an impact plate of the stapler, the split member having a cutting portion extending laterally to the first direction, the T-shaped staple unit extending partially beyond the cutting portion in the first direction for being impacted by the impact plate; wherein the T-shaped staple unit includes a plurality of T-shaped staple members continuously arranged in line, the cutting portion has a support face and a guide face, the guide face is connected with the support face slantly; wherein the support face is for supporting the T-shaped staple unit, and part of the T-shaped staple members is located beyond the support face, suspends and corresponds to the guide face; wherein the cutting portion further includes an abutted section, the abutted section protrudes from the support face and is for being abutted against laterally by the T-shaped staple unit; wherein the split member further includes a connection portion, the connection portion is perpendicular to the cutting portion and the first direction; the connection portion is clamped by a clamping portion of the second rail to be positioned at the first end portion; wherein as viewed in the first direction, the split member is substantially T-shaped; wherein the first and second rails are detachably inserted into and positioned on the base; wherein the magazine assembly further includes a pushing mechanism, the pushing mechanism has a pushing member, at least one resilient member, a pivot member and a via groove disposed through the first and second rails, the via groove extends along the first direction, the pivot member slidably is disposed in the via groove and connected with the pushing member, one end of the resilient member is connected with the first end portion and another end of the resilient member is connected with the pushing member so that the resilient member bias the pushing member toward the first end portion; wherein the magazine assembly further includes a positioning mechanism disposed at the second end portion, the positioning mechanism is for being abutted against by and positioned with the stapler; wherein the first side wall faces in a direction away from the second rail, the second side wall faces the second rail; wherein the first rail further includes a top portion and a bottom portion which are connected with the first side wall and the second side wall, the bottom portion is connected with the base, the top portion has an inclined face, the inclined face extends slantly from the second side wall toward the first side wall and the base slantly, the inclined face is for being abutted against by the head of the T-shaped staple unit; wherein a number of the at least one guiding portion is two and a number of the at least one rib portion is two, a distance between the guiding portions is substantially equal to a shortest distance between the inclined face and one of the guiding portions which is closest to the inclined face; wherein a longest distance between the first rail and the base is substantially equal to a longest distance between the second rail and the base.

9. A stapler including the magazine assembly of claim 1, further including: a main body, including a pressing member, a shell and an impact plate, the shell having a receive portion receiving the magazine assembly, the magazine assembly and the shell defined a discharge opening therebetween, the discharge opening is for corresponding by the staple unit, the pressing member and the impact plate driving mutually, when the pressing member is moved relative to the shell, the pressing member drives the impact plate to move toward the discharge opening to discharge part of the staple unit.

10. The stapler of claim 9, wherein the main body further includes an elastic plate disposed in the shell, the elastic plate has a fixation portion abutting against the shell and a swing portion, the swing portion is connected to the impact plate and bends relative to the fixation portion, and when the pressing member is moved relative to the shell to a predetermined position, the elastic plate drives the impact plat move toward the discharge opening.
